(19) United States
(12) Patent Application Publication
(10) Pub. No.: US 2007/0084976 A1
(43) Pub. Date: Apr. 19, 2007

(54) Thigh-attached mouse pad

(76) Inventors: Pierre Antoine Bate II, Northridge, CA (US); Jonathan R. DeRoche, Northridge, CA (US)

Correspondence Address: ALBERT O COTA, 5460 WHITE OAK AVE, SUITE A-331, ENCINO, CA, 91316, US

(21) Appl. No.: 11/251,649

(22) Filed: Oct. 17, 2005

(51) Int. Cl. B68G 5/00

(52) U.S. Cl. 248/118

(57) ABSTRACT

A thigh-attached mouse pad (10), also known as “the kneePAD™”, consisting of a pad assembly (12) and a pad-to-thigh strap assembly (60). The strap assembly (60) is adjustably attached around a person's thigh (98) adjacent the person's knee (99). The pad assembly (12) is designed to be detachably attached to the strap assembly (60). The pad assembly (12) has an ergonomic shape consisting of an upper circular section (16) that overlaps a smaller, lower circular section (18) to form a modified “keyhole” shape. The upper surface of the pad assembly (12) has a smooth surface that allows a mouse user to easily and comfortably traverse the mouse (100) across the upper surface of the pad assembly (12). The pad assembly (12) also includes a mouse pouch (36) that is dimensioned to partially enclose a mouse when the mouse is not in use or to enclose a resilient hand and wrist support (54) when the mouse is in use.

### TECHNICAL FIELD

The invention pertains to the general field of computer mouse pads and more particularly to a mouse pad that utilizes a pad-to-thigh strap assembly that allows the mouse pad to be easily attached to and removed from a person's thigh.

### BACKGROUND ART

The use of a computer mouse that is manipulated on a mouse pad to control a cursor visible on a computer monitor is well known in the prior art. Typically, the mouse is operated on a mouse pad that is placed on a horizontal surface adjacent the computer keyboard. Unfortunately the prolonged use of a mouse that is placed and used on a conventional mouse pad can cause incidents of hand and wrist fatigue.

The invention can aid in reducing incidents of hand and wrist fatigue by placing the mouse on a thigh-attached mouse pad. The inventive pad positions a person's hand and wrist at a lower, more natural and comfortable angle. Additionally, a hand and wrist support can be placed into a mouse pouch that is located on the upper surface of the pad. The support allows the person's hand and wrist to further be placed in an even more natural position, thus, further reducing hand and wrist fatigue.

A search of the prior art did not disclose any literature or patents that read directly on the claims of the instant invention. However, the following U.S. patents are considered related:

| PATENT NO. | INVENTOR | ISSUED |
|---|---|---|
| 5,779,211 | Bird | 14 Jul. 1998 |
| 5,593,128 | Odom, et al | 14 Jan. 1997 |
| 5,355,811 | Brewer | 18 Oct. 1994 |

The 5,779,211 patent discloses a portable mouse pad which attaches to a user's leg by means of an elastic strap. The mouse pad allows a computer user to operate a mouse from a variety of positions and to change from one position to another. A mouse holding pocket is built into the portable mouse pad.

The 5,593,128 patent discloses a work surface for operating a computer mouse placed on the lap or on the thigh of a person using a computer while the person's hands and arms are in a natural resting position while seated. The work surface has a retaining wall partially around its perimeter which keeps the mouse from rolling off the operating surface when the mouse is left unattended.

The 5,355,811 patent discloses a leg supported mouse pad that is designed to enable a person to use a mouse directly over his or her upper leg or thigh while sitting. The leg supported mouse pad includes a saddle structure capable of engaging the person's thigh and horizontally aligning a planar mouse pad attached thereto. The saddle structure includes a rectangular-shaped flexible panel with two five-sided support members attached to the upper surface on opposite sides of the flexible panel's transverse axis.

For background purposes and as indicative of the art to which the invention relates, reference may be made to the following remaining patents found in the search:

| PATENT NO. | INVENTOR | ISSUED |
|---|---|---|
| D453,163 | Pitlo | 29 Jan. 2002 |
| 6,032,913 | Daw | 7 Mar. 2000 |
| 5,765,790 | Kuldvere | 16 Jun. 1998 |
| D392,960 | Giorgio | 31 Mar. 1998 |

### DISCLOSURE OF THE INVENTION

The thigh-attached mouse pad, also known as “the kneePAD™”, in its basic design configuration is comprised of a pad-to-thigh strap assembly that has attached a pad assembly. The strap assembly is dimensioned to be placed around a person's thigh and secured to the thigh by a hook and loop fastener. The pad assembly has an ergonomic shape that includes an upper surface, a lower surface, an upper area, a lower area and a perimeter edge. The lower surface of the pad assembly is attached to the pad-to-thigh strap assembly by complimentary sections of a hook and loop fastener. When the pad assembly is attached, a mouse user can comfortably and easily traverse the mouse across the upper surface of the pad assembly.

The ergonomic shape of the pad assembly is obtained by having the upper area of the pad assembly consist of an upper circular section and the lower area consist of a smaller, lower circular section. The upper circular section overlaps the lower and smaller circular section, leaving on each side of the pad assembly an area that is filled-in by an inward-radiused section to form a modified “keyhole” shape. The pad assembly is comprised of a rigid substrate having an upper surface and a lower surface, a mouse interface material that is attached to the upper surface of the substrate, and a hook and loop fastener that is attached to the lower surface of the substrate. The mouse interface material and the hook and loop fastener are attached to the substrate by a welt that is stitched around the perimeter edge of the pad assembly.

To enhance the utility of the thigh-attached mouse pad, the pad assembly can be designed to include a mouse pouch and a resilient hand and wrist support.

The mouse pouch is attached over the mouse interface material and is dimensioned to partially enclose a mouse when the mouse is not in use. The resilient hand and wrist support is dimensioned to be inserted into the mouse pouch when the mouse is in use. The use of the support helps to reduce incidents of hand and wrist fatigue by placing the hand and wrist in a more natural position when the mouse is being used.

In view of the above disclosure, the primary object of the invention is to produce an ergonomically shaped mouse pad that can be comfortably attached to a person's thigh by means of an adjustable pad-to-thigh strap assembly.

In addition to the primary object of the invention it is also an object of the invention to produce a thigh-attached mouse pad that:
can be made in various sizes,
can be made in various materials,
can be made with or without a mouse pouch,
can include personal and advertising indicia,
can be easily packaged for storage and shipping,
is cost effective for both a manufacturer's and consumer's point of view,
helps to reduce Repetitive Stress Injuries (R.S.I.) by allowing a user to comfortably access and traverse a mouse over the mouse pad,
can be used with both a wireless or a wire-attached mouse.

These and other objects and advantages of the present invention will become apparent from the subsequent detailed description of the preferred embodiment and the appended claims taken in conjunction with the accompanying drawings.

### BRIEF DESCRIPTION OF THE DRAWINGS

FIG. 1 is a top plan view of a thigh-attached mouse pad showing a pad assembly with a mouse inserted into a mouse pouch.

FIG. 2 is a bottom plan view of the pad assembly.

FIG. 3 is a side elevational view of the pad assembly.

FIG. 4 is a side elevational and partial cross-sectional view of the pad assembly taken along the lines 4-4 of FIG. 3.

FIG. 5 is a top plan view of a resilient hand and wrist support.

FIG. 6 is a top plan view of a pad-to-thigh strap assembly that attaches and secures the pad assembly around a person's thigh.

FIG. 7 is a bottom plan view of the pad-to-thigh strap assembly.

FIG. 8 is a side elevational view of pad-to-thigh strap assembly.

FIG. 9 is a top plan view of the thigh-attached mouse pad attached to a thigh by means of the detachable pad-to-thigh strap assembly. FIG. 9 also shows a resilient hand and wrist support inserted into the mouse pouch.

FIG. 10 is a bottom plan view of the thigh-attached mouse pad attached to a thigh by means of the detachable pad-to-thigh strap assembly.

FIG. 11 is a cross-sectional view of a thigh to which is attached the thigh-attached mouse pad by means of the detachable pad-to-thigh strap assembly.

### BEST MODE FOR CARRYING OUT THE INVENTION

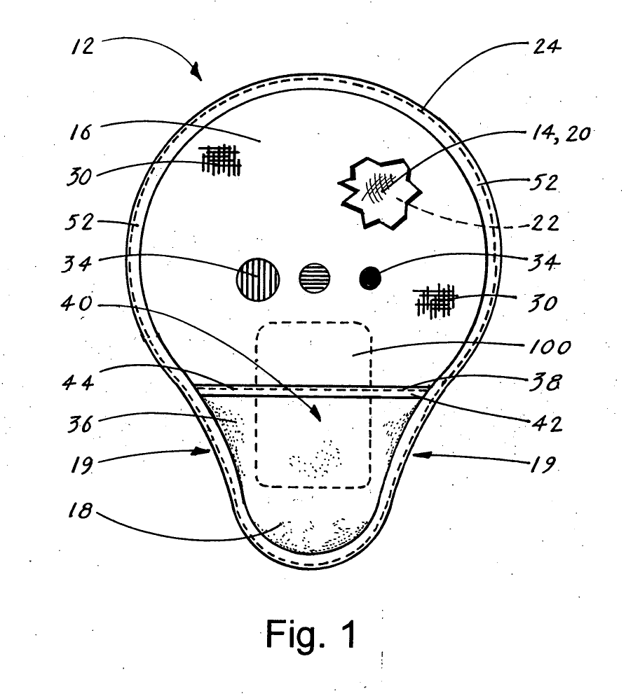

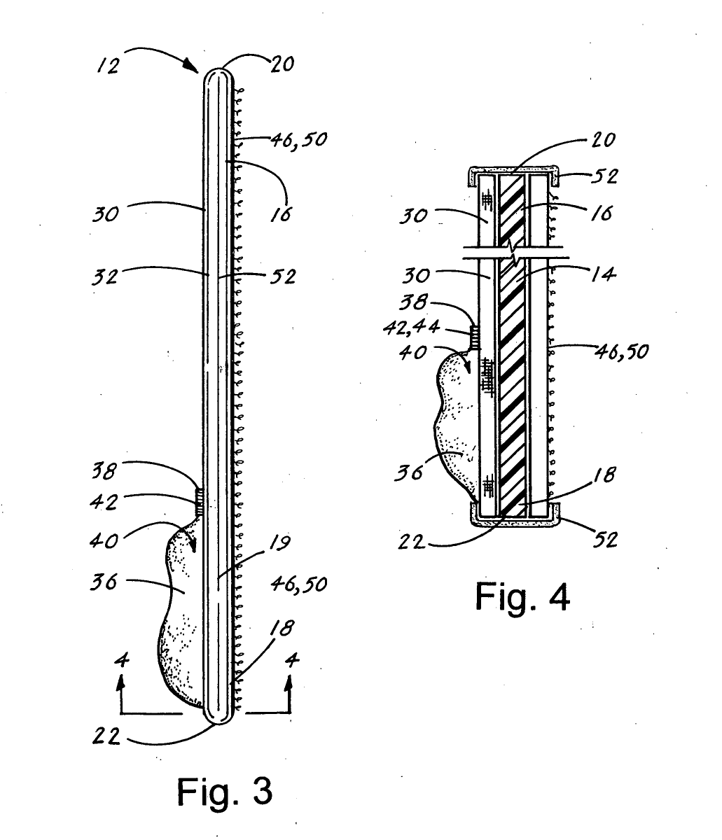

The best mode for carrying out the invention is presented in terms of a preferred embodiment for a thigh-attached mouse pad. The preferred embodiment of the thigh-attached mouse pad 10 (hereinafter “TAMP 10”), as shown in FIGS. 1-11, is comprised of two major elements: a pad assembly 12 and a detachable pad-to-thigh strap assembly 60.

The pad assembly 12, as shown in FIGS. 1-4, is comprised of five elements: a substrate 14, a mouse interface material 30, a mouse pouch 36, a hook and loop fastener 50 and a stitched welt 52.

The substrate 14, as partially shown in FIG. 1 and in cross-section in FIG. 4, has an ergonomic shape that is developed by an upper circular section 16 that overlaps a smaller lower circular section 18. The two overlapping sections 16,18 produce, on each side of the substrate 14 an area that is filled-in and smoothed by an inward-radiused section 19 to form a modified “keyhole” shape. The substrate 14 includes an upper surface 20, a lower surface 22 and a perimeter edge 24, and is made of a rigid plastic that preferably consists of a high-density polyethylene.

The upper surface 20 of the substrate 14 is covered by a mouse interface material 30 that preferably consists of a PVC coated nylon. The material 30, which is attached to the substrate 14 by an attachment means 32, allows a user to easily and comfortably traverse a mouse 100 across the entire upper surface of the pad 12. Optionally, as shown in FIG. 1, indicia 34 can be applied over the material 30.

Attached over the mouse interface material 30, as shown in FIGS. 1 and 4, is a mouse pouch 36 that is attached over the mouse interface material 30 that encompasses the lower circular section 18 of the pad assembly 12. The material used for the mouse pouch preferably consists of neoprene but other stretchable materials can also be utilized. The mouse pouch 36 terminates at an upper edge 38 that has an opening 40 that is resiliently dimensioned to receive and enclose either a wireless mouse 100 or a wired mouse 100. The pouch 36 also includes an elastic band that is attached by stitch 44 to the upper edge 38 of the pouch 36 that further secures an inserted mouse 100.

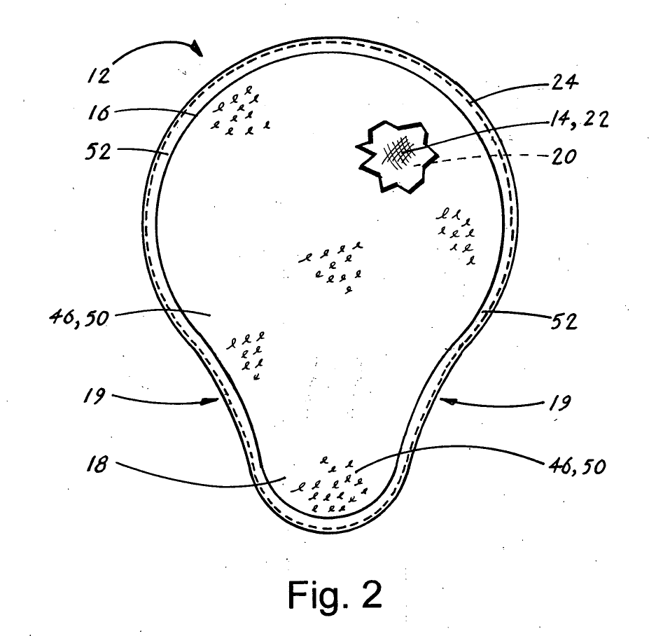

The entire lower surface 22 of the substrate 14, as shown in FIGS. 2, 3 and 4, is covered by a loop section 46 of a hook and loop fastener 50. The loop section 46 is attached by the attachment means 32 which consists of the stitched welt 52 that is placed around the perimeter of the TAMP 10. The stitched welt 52 serves to attach the mouse interface material 30, the mouse pouch 36, and the loop section 46 of the hook and loop fastener 50 to the substrate 14.

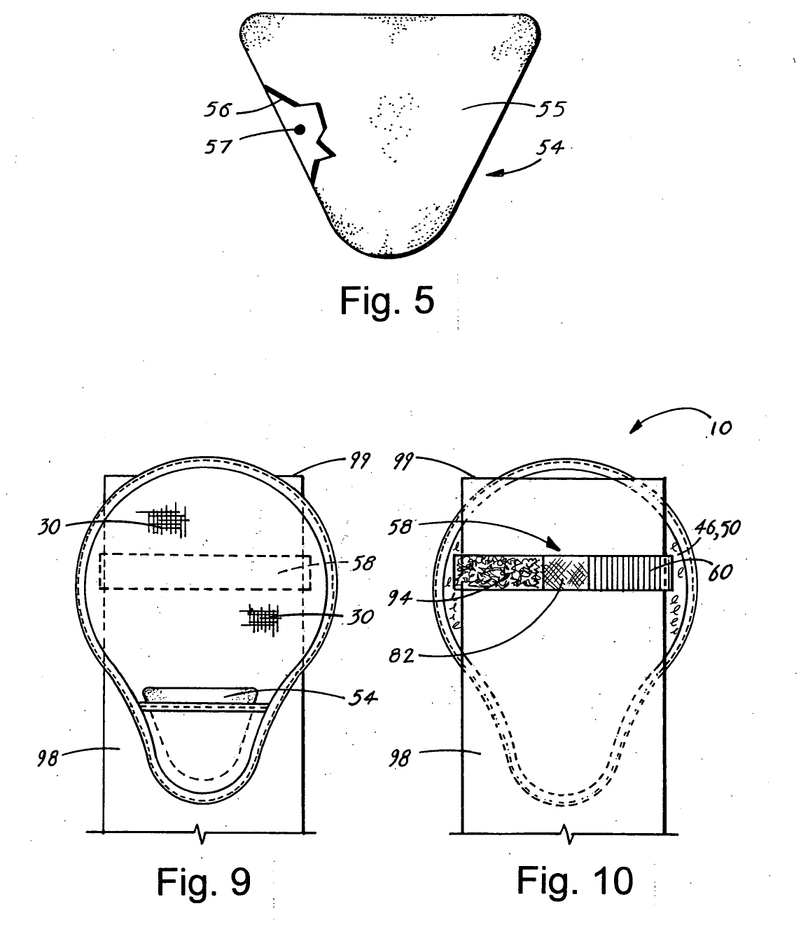

The TAMP 10 can also be designed to include an optional resilient hand and wrist support 54, as shown in FIG. 5. The wrist support 54 is dimensioned to be inserted into the mouse pouch 36 when the mouse is in use. Once the support 54 is inserted, the thickness of the support 54 allows a person's wrist and hand to be aligned on the same plane. Thus, incidents of hand and wrist fatigue such as carpal tunnel syndrome (CTS) or other such ailments can be reduced. The support 54 can be formed of any resilient material 55 such as a soft rubber, a closed-cell foam, a memory foam, or a soft plastic shell 56 can be utilized that is filled with a substance 57 such as a jell, a multiplicity of beads or sand.

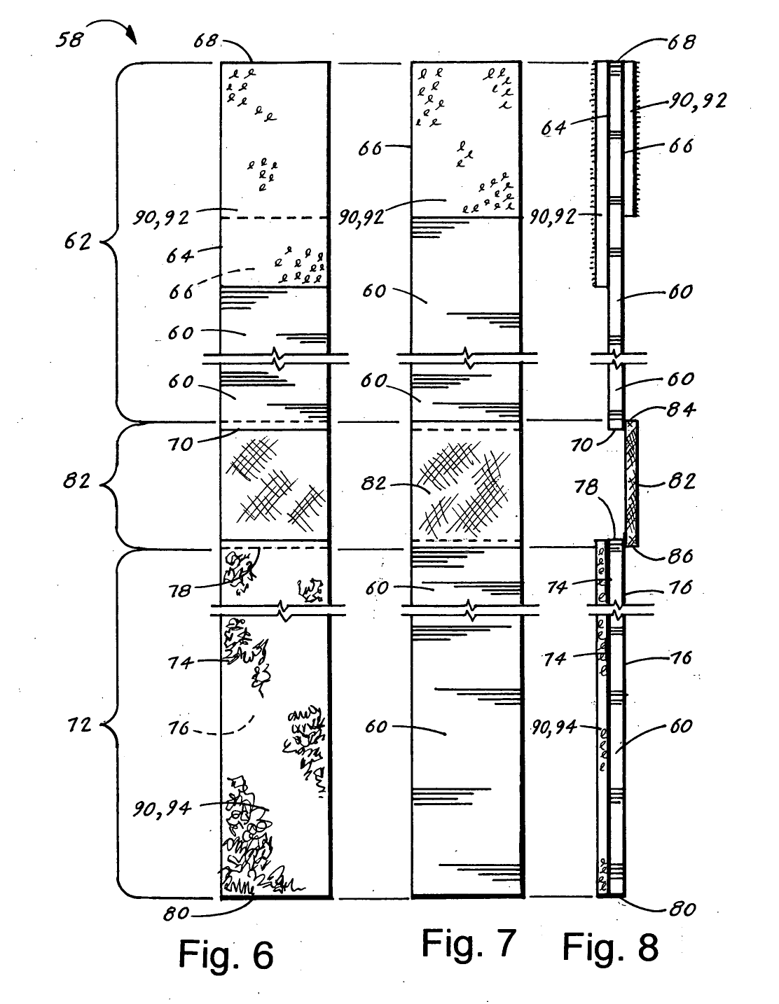

The second major element of the TAMP 10 is the detachable pad-to-thigh strap assembly 58 which is shown in FIGS. 6-8 and 11. The strap assembly 58 is comprised of three elements: a strap 60 having a first section 62, which is attached to a second section 72 by an elastic central section 82.

The first section 62 of the strap 60 has an upper surface 64, a lower surface 66, an outer edge 68 and an inner edge 70. Likewise, the second section 72 has an upper surface 74, a lower surface 76, an inner edge 78, and an outer edge 80. The elastic central section 82, as shown in FIGS. 6-8, has a first edge 84 and a second edge 86.

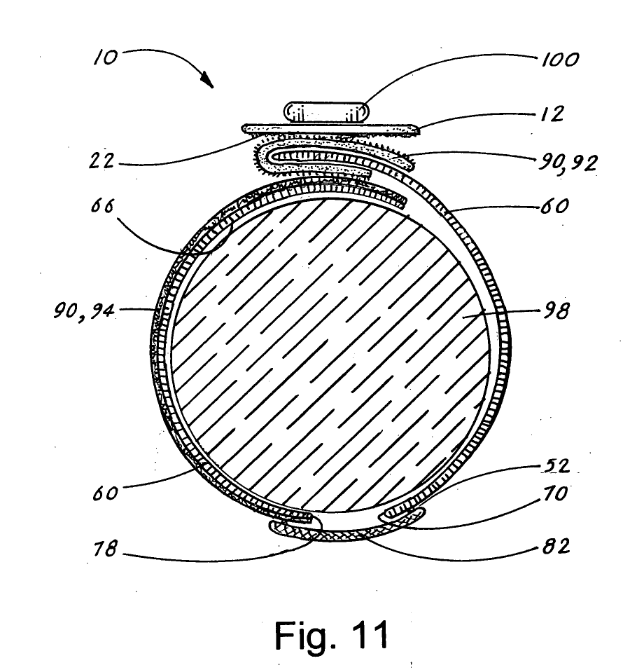

The first edge 84 of the central section 82 is stitched to the inner edge 70 of the first section 62. Likewise, the second edge 86 is stitched to the inner edge 78 of the second section 72. The elastic central section 82 provides the strap assembly 58 provides stretchability that aids in providing a comfortable fit when the strap assembly 58 is attached around a person's thigh 90, as shown in FIG. 11 and as described infra. The strap assembly 58 utilizes a plurality of hook and loop fasteners 90, which are also known as VELCRO®, to complete the strap assembly 58.

As shown in FIG. 6, a hook section 92 of the hook and loop fastener 90 is attached to the upper surface 64 and adjacent the outer edge 68 of the first section 62. A loop section 94 of the hook and loop fastener 90 is also attached to the upper surface 74 and adjacent the outer edge of the second section 72. To the lower surface 66 and adjacent the outer edge 68 of the first section 62 is attached a hook section 92 of the fastener 90.

The pad-to-thigh strap assembly 58, as shown in FIG. 11, is designed to be placed around and attached to a person's thigh 98 by performing the following steps:

1. Place the strap 60 located on the lower surface 76 of the second section 72 on top of a person's right or left thigh 98 so that the loop section 94 located on the upper surface 74 of the second section 72 faces upward.

2. Wrap the strap assembly 58 around the person's thigh 98 and attach the hook section 92 located on the lower surface 66 of the first section 62 to the loop section 94 located on the upper surface 74 of the second section 72.

3. Attach the lower surface 22 of pad assembly 12 over the hook section 92 facing upward, wherein when the pad assembly 12 is attached, the upper area of the pad 12 preferably overlaps the person's knee 99, as shown in FIGS. 9 and 10.

While the invention has been described in detail and pictorially shown in the accompanying drawings it is not to be limited to such details, since many changes and modifications may be made to the invention without departing from the spirit and the scope thereof. For example, the means for attaching the strap assembly 58 to a person's thigh 98 preferably consists of a hook and loop fastener 90, however other fastening means can also be utilized. Additionally, the attaching sections of the hook and loop fastener 90 can be substituted for each other and still function as described. Hence, it is described to cover any and all modifications and forms which may come within the language and scope of the claims.

1. A thigh-attached mouse pad comprising:
a) a pad-to-thigh strap assembly that is dimensioned to be placed around a person's thigh and secured to the thigh by a hook and loop fastener, and
b) a pad assembly having an ergonomic shape that includes an upper surface, a lower surface, an upper area, a lower area and a perimeter edge, wherein the lower surface of said pad assembly is attached to said pad-to-thigh strap assembly by a hook and loop fastener, wherein when said pad assembly is attached, a mouse user can comfortably and easily traverse the mouse across the upper surface of said pad assembly.

2. The thigh-attached mouse pad as specified in claim 1 wherein the ergonomic shape of said pad assembly is obtained by having the upper area consist of an upper circular section and the lower area consist of a smaller, lower circular section, wherein the upper circular section overlaps the lower and smaller circular section to produce on each side of said pad assembly, an area that is filled-in by an inward-radiused section to form a modified “keyhole” shape.

3. The thigh-attached mouse pad as specified in claim 1 wherein said pad assembly is comprised of:
a) a rigid substrate having an upper surface and a lower surface, and
b) a mouse interface material that is attached to the upper surface of the substrate, and a hook and loop fastener that is attached to the lower surface of the substrate, wherein the mouse interface material and the hook and loop fastener are attached to the substrate by a welt that is stitched around the perimeter edge of said pad assembly.

4. The thigh-attached mouse pad as specified in claim 3 wherein said substrate is made of a rigid, high-density polyethylene.

5. The thigh-attached mouse pad as specified in claim 4 wherein the mouse interface material is made of a PVC coated nylon.

6. The thigh-attached mouse pad as specified in claim 3 wherein said pad assembly further comprises a mouse pouch that is attached over the mouse interface material that encompasses the lower circular section of said pad assembly, wherein said mouse pouch is dimensioned to partially enclose a mouse when the mouse is not in use.

7. The thigh-attached mouse pad as specified in claim 6 wherein the said mouse pouch is made of neoprene.

8. The thigh-attached mouse pad as specified in claim 7 wherein said pad assembly further comprises a resilient hand and wrist support that is dimensioned to be inserted into said mouse pouch when the mouse is in use.

9. A thigh-attached mouse pad comprising:
a) a pad assembly comprising:
(1) a substrate having an ergonomic shape that includes an upper surface, a lower surface, an upper area, a lower area and a perimeter edge,
(2) a mouse interface material that is attached to the upper surface of said substrate by an attachment means,
(3) a mouse pouch made of a stretchable material that is attached over the mouse interface material that encompasses the lower area of said substrate, wherein said mouse pouch terminates at an upper edge having an opening that is dimensioned to receive and partially enclose a mouse, wherein said upper edge of said mouse pouch includes an elastic band having edges that are attached to the perimeter edge of said substrate by the attachment means,
(4) a loop section of a hook and loop fastener that is attached to the entire lower surface of said substrate by the attachment means,
(5) a stitched welt that is inserted around the perimeter of said pad assembly, wherein said welt provides the means for attaching said mouse interface material, said mouse pouch and the loop section of the hook and loop fastener to said substrate,
b) a pad-to-thigh strap assembly comprising:
(1) a strap comprised of a first section having an upper surface, a lower surface, outer edge and an inner edge, and a second section having an upper surface, a lower surface, an inner edge and an outer edge,
(2) an elastic central section having a first edge and a second edge, wherein the first edge is attached to the inner edge of said first section, and the second edge is attached to the inner edge of said second section,
(3) a hook section of a hook and loop fastener attached to the upper surface and adjacent the outer edge of said first section,
(4) a loop section of a hook and loop fastener attached to the upper surface and adjacent the outer edge of the second section,
(5) a hook section of a hook and loop fastener attached to the lower surface and adjacent the outer edge of said first section,
(6) a hook section of a hook and loop fastener attached to the lower surface and adjacent the outer edge of said first section, wherein said pad-to-thigh strap assembly is designed to be placed around and attached to a person's thigh by:
(a) placing the strap located on the lower surface of the second section of said strap assembly on top of a person's thigh so that the loop section located on the upper surface of the second section faces upward,
(b) wrapping said strap assembly around the person's thigh and attaching the hook section located on the lower surface of the first section to the loop section located on the upper surface of the second section, and
(c) attaching the lower surface of said pad assembly over the hook section facing upward, wherein when said pad assembly is attached, the upper area of said substrate preferably overlaps the person's knee.

10. The thigh-attached mouse pad as specified in claim 9 wherein the ergonomic shape of said substrate is obtained by having the upper area consist of an upper circular section, and the lower area consist of a smaller, lower circular section, wherein the upper circular section overlaps the lower and smaller circular section to produce on each side of said substrate an area that is filled-in by an inward radiused section to form a modified “keyhole” shape.

11. The thigh-attached mouse pad as specified in claim 9 wherein said substrate is made of a rigid, high-density polyethylene.

12. The thigh-attached mouse pad as specified in claim 9 wherein the mouse interface material is made of a PVC-coated nylon.

13. The thigh-attached mouse pad as specified in claim 9 wherein the stretchable mouse pouch material is made of neoprene.

14. The thigh-attached mouse pad as specified in claim 9 further comprising a resilient hand and wrist support that is dimensioned to be inserted into said mouse pouch when the mouse is in use.

15. The thigh-attached mouse pad as specified in claim 14 wherein said resilient hand and wrist support is made of a material selected from the group consisting of soft rubber, closed-cell foam and memory foam.

16. The thigh-attached mouse pad as specified in claim 14 wherein said resilient hand and wrist support is comprised of a soft plastic shell that is filled with a substance selected from the group consisting of a jell, a multiplicity of beads and a multiplicity of sand.

17. The thigh-attached mouse pad as specified in claim 9 wherein the strap material is made of polypropylene.

18. The thigh-attached mouse pad as specified in claim 12 further comprising indicia that is printed over the mouse interface material.
